(19) United States
(12) Patent Application Publication
(10) Pub. No.: US 2011/0178858 A1
(43) Pub. Date: Jul. 21, 2011

(54) ELECTRONIC SHOPPING SYSTEM

(75) Inventors: TEH-SHEN LEE, Tu-Cheng (TW); YI-WEN CHO, Tu-Cheng (TW); MING-TESUNG CHENG, Tu-Cheng (TW); MING-CHOU CHANG, Tu-Cheng (TW)

(73) Assignee: HON HAI PRECISION INDUSTRY CO., LTD., Tu-Cheng (TW)

(21) Appl. No.: 12/791,873

(22) Filed: Jun. 2, 2010

(30) Foreign Application Priority Data
Jan. 19, 2010 (CN) 201010300447.2

(51) Int. Cl. G06Q 30/00; G06F 17/00; G06F 3/048; G09G 3/36

(52) U.S. Cl. 705/14.23; 235/375; 715/835; 345/87

(57) ABSTRACT

An electronic shopping system includes a mobile terminal comprising a non-volatile display unit, a volatile display unit, a microprocessor and a receiving unit configured to receive sales information from a server. The sales information comprise coupons, merchandise sort icons, and merchandise name icons, and each of the merchandise sort icons is associated with a part of the merchandise name icons, and each of the merchandise name icons is associated with one of the coupons, each of the coupon comprises a code. The microprocessor displays the merchandise sort icons and the merchandise name icons on the volatile display unit, and further displays one coupon on the non-volatile display unit.

### BACKGROUND

1. Technical Field

The present disclosure relates to electronic shopping systems and, particularly, to an electronic shopping system having one or more mobile terminals communicating with a server.

2. Description of Related Art

Conventional coupons are usually paper coupons. Paper resources are needed in printing such coupons; moreover, those coupons are easily misplaced or damaged.

### BRIEF DESCRIPTION OF THE DRAWINGS

The components of the drawings are not necessarily drawn to scale, the emphasis instead being placed upon clearly illustrating the principles of an electronic shopping system. Moreover, in the drawings, like reference numerals designate corresponding parts throughout multiple views.

FIG. 1 is a schematic view of an electronic shopping system in accordance with a first exemplary embodiment.

FIG. 2 is a block diagram of a mobile terminal of the electronic shopping system of FIG. 1.

FIGS. 3A-3B are schematic views showing interfaces displayed by the mobile terminal of FIG. 2.

FIG. 4 is a schematic view of an electronic shopping system in accordance with a second exemplary embodiment.

FIG. 5 is a block diagram of a mobile terminal of the electronic shopping system of FIG. 4.

### DETAILED DESCRIPTION

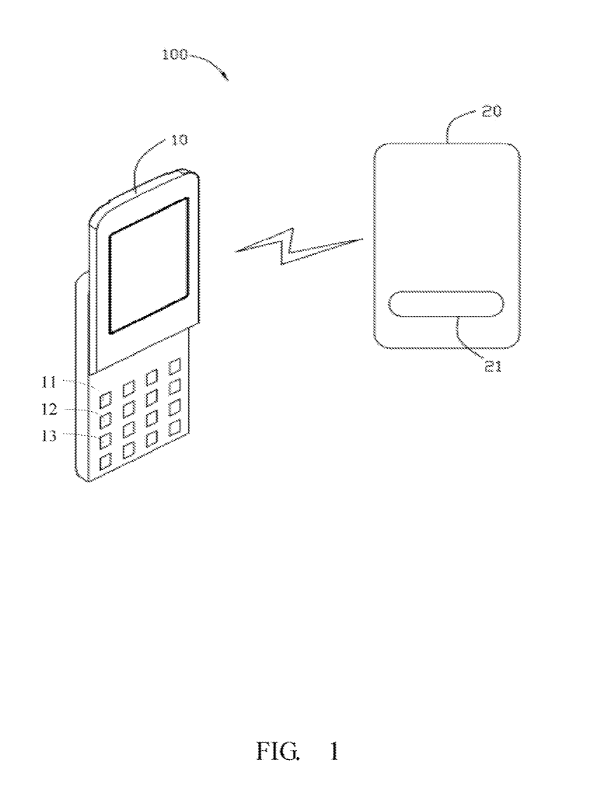

Referring to FIG. 1, a schematic view of an electronic shopping system 100 in accordance with a first exemplary embodiment is illustrated. The electronic shopping system 100 includes at least one mobile terminal 10 and a server 20 provided by an emporium or the like for transmitting sales information within a predetermined region. In the embodiment, the number of the mobile terminals 10 is one. The sales information includes coupons, merchandise sort icons, and merchandise name icons. Each merchandise sort icon is associated with a part of the merchandise name icons. Each merchandise name icon is associated with one coupon. Each of the coupons contains an image of a code, such as a bar code, which can be identified by a payment terminal (not shown), a price, and so on.

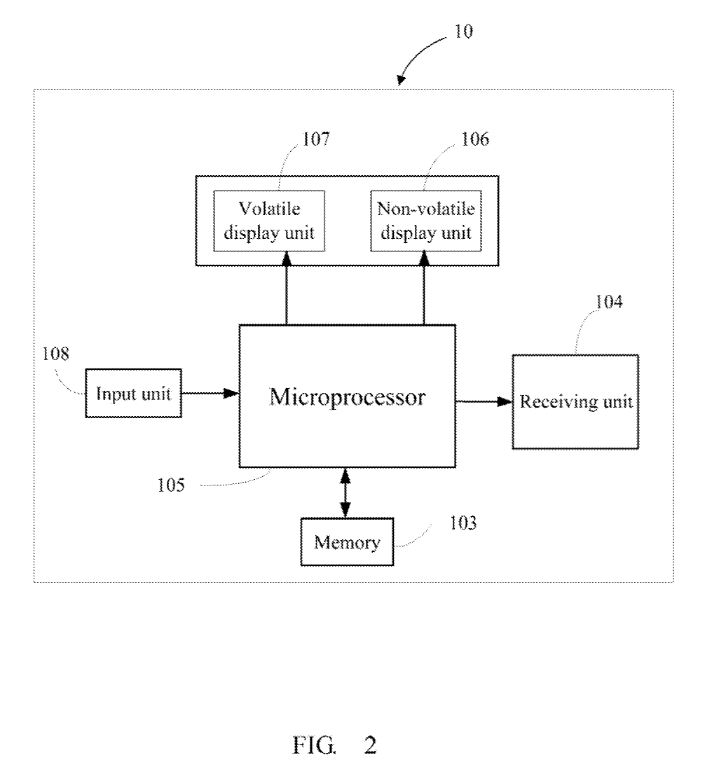

Referring also to FIG. 2, the mobile terminal 10 includes a memory 103, a receiving unit 104, a microprocessor 105, a non-volatile display unit 106, a volatile display unit 107, and an input unit 108.

The receiving unit 104 is configured for receiving the sales information from the server 20 when the mobile terminal 10 is in the predetermined region. The received sales information is stored in the memory 103 by the microprocessor 105. The non-volatile display unit 106 is an E-paper display. The code of one coupon displayed on the non-volatile display unit 106 can be read by the payment terminal (not shown). The volatile display unit 107 is an LCD (Liquid Crystal Display) screen or a CRT (Cathode-Ray Tube) display screen.

The microprocessor 105 selectively displays the sales information on the non-volatile display 106 and the volatile display unit 107 according to the file formats of the sales information. In the embodiment, the microprocessor 105 displays information recorded in picture format on the volatile display unit 107 and displays information recorded in text format on the non-volatile display unit 106. In the embodiment, each of the coupons is recorded in text format, and each of the merchandise sort icons and each of the merchandise name icons are recorded in picture format.

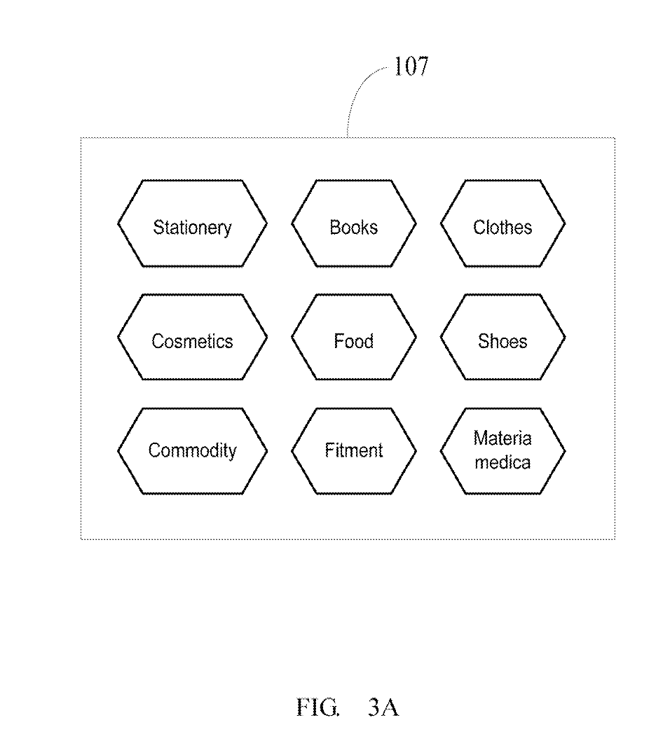

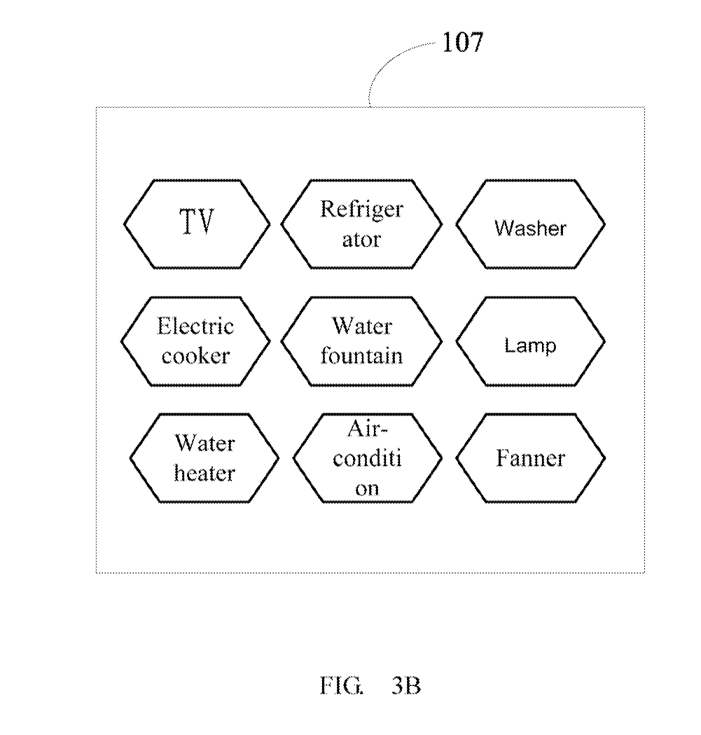

In the embodiment, the input unit 108 includes a display button 11, a confirm button 12, and at least one direction button 13. The display button 11 is configured to generate a display signal for displaying the sort icons. The confirm button 12 is configured to generate a confirm signal. Each of the direction buttons 13 is configured for a user to select the displayed information. In the embodiment, when the microprocessor 105 receives the display signal, the microprocessor 105 displays the merchandise sort icons on the volatile display unit 107 (see FIG. 3A). If the user selects one displayed sort icon and the confirm button 12 is pressed, the microprocessor 105 displays the merchandise name icons associated with the selected merchandise sort icon on the volatile display unit 107 (see FIG. 3B). If the user selects one displayed merchandise name icon and the confirm button 12 is pressed, the microprocessor 105 displays one coupon associated with the selected merchandise name icon on the non-volatile display unit 106. The code of the displayed coupon can be read by the payment terminal.

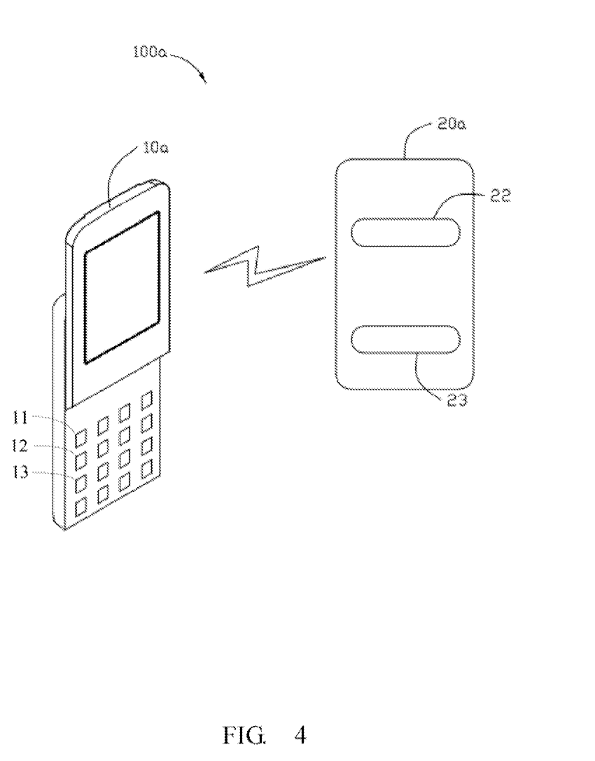

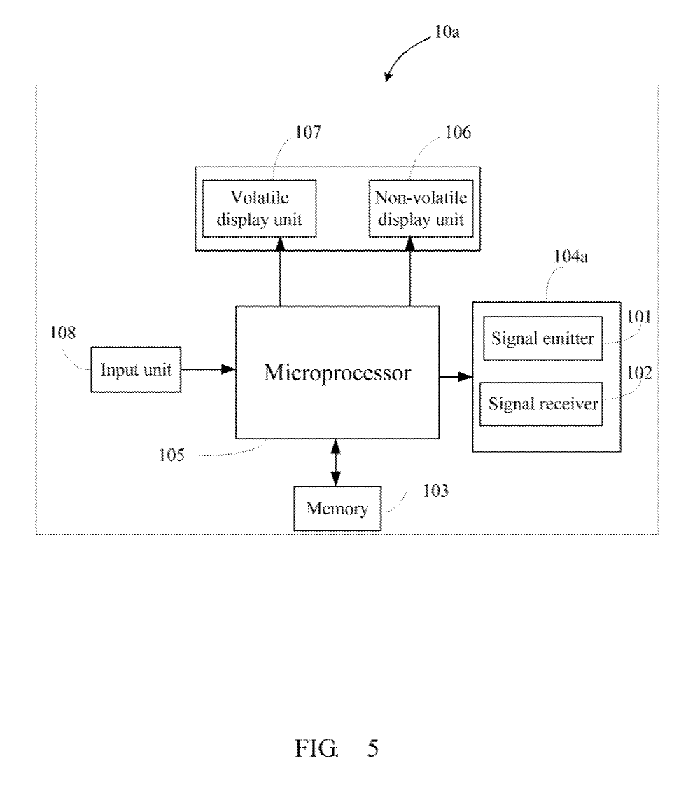

Referring to FIGS. 4-5, an electronic shopping system 100a slightly different from the electronic shopping system 100 is illustrated. The system 100a also includes a mobile terminal 10a and a server 20a. The mobile terminal 10a includes a receiving unit 104a, the receiving unit 104a further includes a signal emitter 101 and a signal receiver 102. The signal emitter 101 is configured to emit signals to the server 20a via Wi-Fi, BLUETOOTH, RFID, or the like. The signal receiver 102 is configured to receive signals from the server 20a. If the server 20a receives the signal from the mobile terminal 10a, the server 20a transmits the sales information as described above to the terminal 10a. The terminal 10a also includes a memory 103, a microprocessor 105, a non-volatile display unit 106, a volatile display unit 107, and an input unit 108. The functions of the memory 103, the microprocessor 105, the non-volatile display unit 106, the volatile display unit 107 and the input unit 108 are the same as that of the terminal 100.

Compared to the system 100, in the system 100a, the server 20a transmits the sales information to the terminal 10a after receiving the signal from the terminal 100a. Therefore, only the terminals which can communicate with the server 20a can obtain the coupons.

In the embodiment, the coupons displayed on the non-volatile display can be identified by the payment terminal, which conserves papers.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An electronic shopping system, comprising:
a mobile terminal comprising:
a non-volatile display unit;
a volatile display unit;
a receiving unit configured to receive sales information from a server, wherein the sales information comprise coupons, merchandise sort icons, and merchandise name icons, each of the merchandise sort icons is associated with a part of the merchandise name icons, and each of the merchandise name icons is associated with one of the coupons, each of the coupon comprises an image of a code enabling the coupon to be identified by a payment terminal; and
a microprocessor configured to display the merchandise sort icons on the volatile display unit, and the merchandise name icons associated with one selected merchandise sort icon on the volatile display unit, and further displaying one coupon associated with one selected merchandise name icon on the non-volatile display unit.

2. The electronic shopping system as described in claim 1, wherein the mobile terminal further comprises an input unit, the input unit comprises a display button, a confirm button, and at least one direction button, the display button is configured to generate a display signal for displaying the sort icons; the confirm button is configured to generate a confirm signal; each of the at least one direction buttons is configured to select the displayed information.

3. The electronic shopping system as described in claim 1, wherein when the mobile terminal is in a predetermined region, the receiving unit receives the sales information from the server.

4. The electronic shopping system as described in claim 1, wherein the receiving unit comprises a signal emitter and a signal receiver, the signal emitter is configured to emit signals to the server, when the server receives the signal from the mobile terminal, the server transmits the sales information to the mobile terminal.

5. The electronic shopping system as described in claim 1, wherein the non-volatile display unit is an E-paper display screen, the volatile display unit is an LCD screen or a CRT display screen.

6. A mobile terminal comprising:
a non-volatile display unit;
a volatile display unit;
a receiving unit configured to receive sales information from a server, wherein the sales information comprise coupons, merchandise sort icons, and merchandise name icons, each of the merchandise sort icons is associated with a part of the merchandise name icons, and each of the merchandise name icons is associated with one of the coupons, each of the coupon comprises an image of a code enabling the coupon to be identified by a payment terminal; and
a microprocessor configured to display the merchandise sort icons on the volatile display unit, and the merchandise name icons associated with one selected merchandise sort icon on the volatile display unit, and further displaying one coupon associated with one selected merchandise name icon on the non-volatile display unit.

7. The mobile terminal as described in claim 1, further comprising an input unit, the input unit comprising a display button, a confirm button, and at least one direction button, the display button configured to generate a display signal for displaying the sort icons; the confirm button configured to generate a confirm signal; each of the at least one direction buttons configured to select the displayed information.

8. The mobile terminal as described in claim 1, wherein when the mobile terminal is in a predetermined region, the receiving unit receives the sales information from the server.

9. The mobile terminal as described in claim 1, wherein the receiving unit comprises a signal emitter and a signal receiver, the signal emitter is configured to emitter signals to the server, when the server receives the signal from the mobile terminal, the server transmits the sales information to the mobile terminal.

10. The mobile terminal as described in claim 1, wherein the non-volatile display unit is an E-paper display screen, the volatile display unit is an LCD screen or a CRT display screen.
